(19) United States
(12) Patent Application Publication
(10) Pub. No.: US 2026/0019887 A1
(43) Pub. Date: Jan. 15, 2026

(54) MULTI-SCENARIO PREDICTION AND PROACTIVE OPERATIONS IN COMMUNICATION NETWORKS

(71) Applicant: Huawei Technologies Co., Ltd., Shenzhen (CN)

(72) Inventor: Hesham Gamal Aly Mohamed Moussa, Ottawa (CA)

(21) Appl. No.: 19/311,991

(22) Filed: Aug. 27, 2025

Related U.S. Application Data
(63) Continuation of application No. PCT/CN2023/079144, filed on Mar. 1, 2023.

(51) Int. Cl. H04W 28/26; H04L 47/83; H04W 36/00

(52) U.S. Cl. CPC H04W 28/26; H04L 47/83; H04W 36/00837

(57) ABSTRACT

A method, apparatus and system for proactively performing operations in a network, to prepare for potential future events. For each of multiple potential future events which are alternatives of one another, a value indicative of probability of the event occurring is determined. Then, a corresponding process is begun prior to occurrence of the event. The process is performed to an extent which is an increasing function of the probability of the event. The process accommodates requirements related to the event. Applications to mobile device handover and user plane function selection are included.

### CROSS-REFERENCE TO RELATED APPLICATIONS

This application is a continuation of International Patent Application No. PCT/CN2023/079144, filed Mar. 1, 2023, entitled “MULTI-SCENARIO PREDICTION AND PROACTIVE OPERATIONS IN COMMUNICATION NETWORKS,” the contents of which are incorporated herein by reference in its entirety.

### TECHNICAL FIELD

This invention pertains generally to the field of communication networks and in particular to prediction-based operations in such networks to mitigate time delays.

### BACKGROUND

In current (e.g. 5G) mobile networks, many basic functions of the mobile network follow a predefined set of steps executed in reaction to a trigger. The trigger is generated upon the occurrence of a certain network event that requires a modification in the network configurations, in order for the network to be able to handle the event. These functions include beamforming, handover, interference management, modulation and coding selection, and user plane function (UPF) discovery and selection, among others. Once a process trigger is received at a network entity, the steps within its enclosed process can be executed. That is, execution of the process starts at a time when the trigger is received, and can run until its execution is complete. Under this mode of operation, the network is considered to be reactive, because a trigger is required for the process to start executing.

FIG. 1 illustrates a method to begin executing a reactive process of typical functions within a mobile network, according to the prior art. An event 105 causes a trigger 110 to be generated. The trigger causes a first process 117 to begin from step 1 at a given network entity, in this case network entity 2 115. The execution time of this first process is Tₑₓ and thus the time delay from receiving the trigger to completing the process is also at least Tₑₓ.

In an example scenario, network connectivity for devices along a road section is provided by a local device, such as a drone cell, using visible light communication (VLC). At a first time tₒ, there is a line of sight (LoS) VLC-link between the cell and a first vehicle passing underneath. However, at a later time tₒ+Δt, a second vehicle blocks the LoS link. Nevertheless, the LoS blockage will be for a very short time interval during which the first vehicle loses connectivity. Typically, the network is reactive; meaning a LOS blockage results in negative acknowledgements (NACKs) for some of the packets transmitted during the LoS blockage interval. Those NACKs would trigger a delayed response that might be unnecessary or inaccurate because the drone cell is not aware of the reason for the NACK, and by the time it reacts, the second vehicle would have already passed. Thus, reacting to event triggers can not only cause operational delays, but, if the events are short lived, unnecessary outages can result.

In this and other examples, networks experience operational delays for a variety of reasons. These delays may impact performance and user experience.

A variety of approaches have been proposed in order to provide for proactive network operations in order to mitigate such operational delays. M. S. Mollel et al., “A Survey of Machine Learning Applications to Handover Management in 5G and Beyond,” in IEEE Access, vol. 9, pp. 45770-45802, 2021, doi: 10.1109/ACCESS.2021.3067503 surveys machine learning applications to handover management in 5G networks and beyond. H. A. Kassir, Z. D. Zaharis, P. I. Lazaridis, N. V. Kantartzis, T. V. Yioultsis and T. D. Xenos, “A Review of the State of the Art and Future Challenges of Deep Learning-Based Beamforming,” in IEEE Access, vol. 10, pp. 80869-80882, 2022, doi: 10.1109/ACCESS.2022.3195299 reviews the state of the art and future challenges of deep learning-based beamforming. I. A. Bartsiokas, P. K. Gkonis, D. I. Kaklamani and I. S. Venieris, “ML-Based Radio Resource Management in 5G and Beyond Networks: A Survey,” in IEEE Access, vol. 10, pp. 83507-83528, 2022, doi: 10.1109/ACCESS.2022.3196657 surveys machine learning based radio resource management techniques. The 3GPP standard has identified new network functions, such as NWDAF and MDA to be the bases for intelligence and data analytics in the core network and in management and orchestration respectively.

In such approaches, prediction models are used to predict a potential future scenario, and a single related process or network function is fully executed based on the prediction, without necessarily waiting for the event to occur or for a related trigger to be received. The assumption is that the predicted scenario is guaranteed to happen. However, this assumption is not necessarily realistic. Therefore, mispredictions can occur with significant consequence to operations and resource usage.

Therefore, there is a need for methods, apparatus and systems that obviates or mitigates one or more limitations in the prior art.

This background information is intended to provide information that may be of possible relevance to the present disclosure. No admission is necessarily intended, nor should be construed, that any of the preceding information constitutes prior art against the present disclosure.

### SUMMARY

Embodiments of the present disclosure provide for a method, apparatus and system which proactively implements network operations in a manner which accounts for uncertainty. In various embodiments, multiple potential future events (e.g. network demands) which are alternatives to one another are identified, and multiple corresponding processes are begun proactively and concurrently. Each process is for accommodating requirements related to one of the potential future events. In some embodiments, a process corresponding to at least one of the potential events is performed, proactively (in advance of the event), to an extent which is commensurate with the probability of the potential event occurring. For example, the extent (e.g. number of steps starting from the beginning of the process) may be an increasing function (including possibly a nondecreasing function) of this probability. The probability may be replaced with another value which is indicative, to some degree, of the probability. A trigger, indicative that one of the potential events has actually occurred, can subsequently cause the corresponding process to continue, for example beginning from the above-mentioned extent to which it has already been performed.

In accordance with an embodiment of the present disclosure, there is provided a method performed by an entity in a communication network. The method includes performing certain actions following a determination, for the communication network, of two or more potential future events which are alternatives of one another. The actions include, for each particular event of the two or more potential future events, determining a value indicative of probability of occurrence of the particular event. The actions further include causing a corresponding process to begin executing by one or more entities in the communication network prior to the occurrence of the particular event. These one or more entities may include or exclude the entity which is performing the method. The process is executed up to an extent which is an increasing function of the value indicative of probability of the occurrence of the particular event. The corresponding process is for accommodating one or more requirements related to the particular event.

In some embodiments, the method includes, prior to the occurrence of the event: subsequently determining a revised value indicative of probability of the occurrence of the event; and causing the corresponding process for the event to execute to a modified extent which is an increasing function of the revised value. In some further embodiments, when the revised value is less than the value indicative of probability of occurrence of the event as previously determined, and the executing to the extent includes reserving network resources, the executing to the modified extent includes releasing the reserved network resources.

In some embodiments, the method includes (e.g. subsequently) receiving a trigger indicative of occurrence of a particular event of the two or more potential future events; and in response to the trigger, using results, of the executing of the corresponding process associated with the particular event, to accommodate one or more requirements of the particular event. The trigger may be a message, control signal, or observed behavior of a network entity, for example. In some embodiments, the accommodating of the one or more requirements of the particular event includes completing the corresponding process associated with the particular event, starting from the extent to which the corresponding process associated with the particular event was previously executed. In some embodiments, the method includes, following receipt of the trigger, abandoning or reverting each of the corresponding processes which are associated with each of the two or more potential future events other than the particular event.

In some embodiments, each different process of the corresponding processes is executed using a different respective set of the one or more entities (e.g. nodes of the communication network).

In various embodiments, the above-mentioned entity, at least one of the above-mentioned one or more entities, or a combination thereof includes one or more of: a user equipment, one or more base stations serving the user equipment, a base station which is a neighbor base station of the user equipment, an entity in a core network, or any component(s)/chipset(s) within them.

In some embodiments, each corresponding process corresponds to one of: a process for handing over a user equipment between base stations; a process for user plane function discovery for accommodating the user equipment; and a process for beam selection at a base station for communicating with the user equipment.

In accordance with embodiments, there is provided a method performed by an entity in a communication network. The method includes performing certain actions following a determination, for the communication network, of two or more potential base stations with which a mobile user equipment may potentially communicate at a future time. The actions include, for each base station of the two or more potential base stations: determining a value indicative of probability of initiating by the mobile user equipment a handover to the base station. The actions further include causing a corresponding process to begin executing by one or more entities in the communication network prior to the initiating the handover to the base station. The executing is performed up to an extent which is an increasing function of the value indicative of probability of the initiating the handover. The corresponding process includes preparing for the handover.

In some embodiments, the method further includes, prior to the initiating the handover: subsequently determining a revised value indicative of probability of the initiating the handover; and causing the corresponding process to execute to a modified extent which is an increasing function of the revised value. In some embodiments, when the revised value is less than the value indicative of probability of the initiating the handover as previously determined, the executing to the extent includes reserving network resources, and the executing to the modified extent comprises releasing the reserved network resources.

In some embodiments, the method further includes: (e.g. subsequently) receiving a trigger indicative that the mobile user equipment has initiated the handover to a particular one of the base stations; and in response to the trigger, performing the handover to said particular one of the base stations using results of the executing of the corresponding process by the one or more network entities. The network entities may include said particular one of the base stations. In some embodiments, the performing the handover includes completing the corresponding process by the one or more entities, starting from the extent to which the corresponding process was previously executed. In some embodiments, the method further includes, following receipt of the trigger, abandoning or reverting each of the corresponding processes which are associated with each of the two or more potential base stations other than the particular one of the base stations.

In accordance with embodiments, there is provided a method performed by an entity in a communication network. The method includes performing certain actions following a determination, for the communication network, of two or more potential future requests for user plane functions, the two or more potential future requests being alternatives to one another. The actions include, for each request of the two or more potential future requests, determining a value indicative of probability of occurrence of the request. The actions include causing a corresponding process to begin executing by one or more entities in the communication network prior to the occurrence of the request. The executing is performed up to an extent which is an increasing function of the value indicative of probability of the occurrence of the request. The process for accommodating the request is at least in part by discovering corresponding user plane functions, linking to discovered user plane functions, or both.

In some embodiments, the method further includes, prior to the occurrence of the request: subsequently determining a revised value indicative of probability of the occurrence of the request; and causing the corresponding process for the request to execute to a modified extent which is an increasing function of the revised value. In some embodiments, when the revised value is less than the value indicative of probability of occurrence of the request as previously determined, and the executing to the extent includes reserving network resources, the executing to the modified extent includes releasing the reserved network resources.

In some embodiments, the method further includes (e.g. subsequently) receiving a trigger indicative of occurrence of a particular request of the two or more potential future requests; and in response to the trigger, using results of the corresponding process associated with the particular request, to accommodate one or more requirements of the particular request. In some embodiments, the accommodating the particular request includes completing the corresponding process associated with the particular request, starting from the extent to which the corresponding process associated with the particular request was previously executed. In some embodiments, the method further includes, following receipt of the trigger, abandoning or reverting each of the corresponding processes which are associated with each of the two or more potential future requests other than the particular request.

In accordance with embodiments, there is provided an electronic apparatus in a communication network, the apparatus comprising a processor, a network interface and a memory and configured to perform one or more of the methods as described above.

In accordance with embodiments, there is provided a communication system comprising at least one apparatus implementing one or more of the methods as described above and one or more network entities involved in the one or more of the methods as described above.

In accordance with an embodiment of the present disclosure, there is provided a computer program product comprising a (e.g. non-transitory) computer readable medium having statements and instructions stored thereon which, when executed by one or more computer processors, cause the computer processors to perform the method as set forth above. The computer processors may be parts of one or more network entities as described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a reactive network process, in accordance with the prior art.

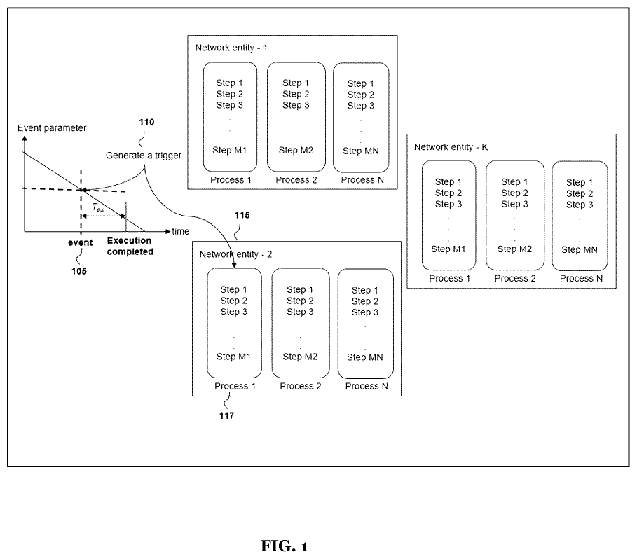

FIG. 2 illustrates a proactive network process and system components, in accordance with embodiments of the present disclosure.

FIG. 3 illustrates further aspects of the proactive network process and system of FIG. 2, in accordance with embodiments of the present disclosure.

FIG. 4 illustrates steps of another proactive network process, in accordance with embodiments of the present disclosure.

FIG. 5 illustrates a proactive network process for UE handover, in accordance with embodiments of the present disclosure.

FIG. 6 illustrates a proactive network process for UPF selection, in accordance with embodiments of the present disclosure.

FIG. 7A illustrates further aspects of the proactive network process for UPF selection of FIG. 6, in accordance with embodiments of the present disclosure.

FIG. 7B illustrates details of operations supporting those of FIG. 7A, according to embodiments.

FIG. 8A illustrates components of a system for proactive network operations, in accordance with embodiments of the present disclosure.

FIG. 8B illustrates components of a system for proactive network operations, in accordance with other embodiments of the present disclosure.

FIG. 9 illustrates an computer apparatus usable to provide system and apparatus components according to embodiments of the present disclosure.

It will be noted that throughout the appended drawings, like features are identified by like reference numerals.

### DETAILED DESCRIPTION OF THE ILLUSTRATIVE EMBODIMENTS

Embodiments of the present disclosure relate to proactive execution of processes in a communication network, where each process is executed up to an extent which is an increasing function of the probability of an event occurring which would require the process to be executed. If and when such an extent is reached, the execution of the process halts or pauses. Multiple processes which accommodate events which are alternatives of one another can be begun concurrently in this manner. The processes can relate to tasks such as mobile user equipment handover, user plane function discovery, communication beam selection, interference management, modulation and coding selection for communication, or the like, or a combination thereof. The processes can be adjusted in response to the assessed probabilities changing.

According to various embodiments, rather than completely eliminating delays due to process execution time, processes may be partially (but not fully) executed proactively in order to reduce such delays. The delays may be reduced while maintaining reliability and controlling overheads. To achieve this, embodiments utilize multi-scenario prediction along with partial programmability. For multi-scenario prediction, multiple potential future events which are alternatives of one another are determined, along with their probabilities (or values approximately or fully indicative of such probabilities) of occurring. For partial programmability, processes for accommodating requirements related to an event are proactively executed only partway, to an extent which is an increasing function of the probability (or associated value) of the event occurring.

A motivating example adopted from the field of autonomous driving follows. Autonomous vehicles rely, in their decision-making processes, on predictions made about future events such as behavior of incoming cars, pedestrians, and drivers' behaviors. Using a large number of mounted sensors on the car, that collect comprehensive information about the surrounding vehicles, an onboard prediction module analyzes the collected data to make predictions. Those predictions are used to guide the behavior of the autonomous vehicle (AV) in a proactive manner. For instance, if the AV predicts that the car in front of it will slow down in a next time frame, the AV will take the necessary steps in proactive manner to avoid a collision. Those steps can be actions such as slowing down proactively or initiating a lane switch. Nevertheless, as the actions of the AV are critical and could lead to costly consequences if not made carefully, the underlying predictions need to be extremely accurate.

Designing an accurate prediction module has been the center of many research efforts. Yet, no matter how accurate a prediction module becomes, in an environment with a human component, there is always a chance of erroneous predictions. This is because, first, human behavior is random, second, the complexity of the data needed to make an accurate prediction is difficult to manage, and third, the environment involves multiple random components (i.e., more than one car and human), making any prediction always susceptible to inaccuracies. As such, more recent efforts have started to explore multi-trajectory predictions where the AV would predict more than one possible scenario and trajectory of the other cars sharing the road with it, and accordingly would choose an action that would best prepare it to handle all possible scenarios.

Analogously, it has been recognized by the inventors that, in future mobile networks, many applications may require seamless connectivity and close to zero delay performance. Proactive operations offers a potential solution. For instance, in a proactive handover operation, the future location of a mobile user equipment may be predicted and a handover to a base station serving that location may be proactively executed, at least to a partial extent.

However, just like in the AV example, mobile network users (e.g. human users) are constantly moving and demanding different types of services. Nevertheless, both the movement of a human and the type of service required at any given time are random or at least not fully predictable. This unpredictability makes many forms of proactive operations unreliable, inefficient in terms of resource usage, or both. Unreliability may stem from the fact that due to severe randomness, the chance that a prediction is correct may decline considerably. Thus, if actions are to be taken upon such unreliable prediction, the chance of making wrong decisions increases significantly. As a countermeasure to reduced reliability, resources may be overbooked or else the predicted event may be otherwise overprepared for. For example, multiple alternative events may be prepared for. However, without further consideration, this approach may result in significant resource wastage. This is because, once the predicted event occurs, many of the preparations for alternative events end up being unneeded, and thus resources and preparations are significantly wasted.

As such, embodiments of the present disclosure provide for proactivity in mobile networks by taking steps to shorten the execution time of network functions in a proactive manner, before a related event occurs. In current mobile networks, there are many functions that involve a series of steps which are triggered once an event happens. Completing these steps take a certain amount of time, referred to as the execution time. Conventionally, in a reactive execution, the execution time is the time interval between the event occurring and the final step of the associated function completing. However, it is recognized herein that many of these functions often include steps that can be executed proactively before the event occurs. Therefore, if some or all of those steps can be executed ahead of time, the overall execution time can be reduced considerably.

Embodiments provide for a method, apparatus and system which utilizes multi-scenario prediction (e.g. via use of prediction modules) to determine a set of potential future events, each having a given probability of occurrence, and which are used to prepare the network proactively. Various embodiments relate to network functions that involve more than one potential target network entity. Target network entities in this context refer to entities that might be involved in handling a predicted potential future event. In various embodiments, it is unknown (until a trigger indicative that one of the potential future events has occurred) which target network entity will be called upon to handle the event. This may be due to multiple potential future events being alternatives of one another, and with processes for accommodating different potential events being executed using a different respective set of entities in the network (e.g. network nodes). Two sets of entities may be different from one another in that the membership of a first set is different from the membership of a second set. E.g. the first set can be missing a member which is part of the second set. The second set may possibly also be missing a member which is part of the first set. The two different sets of entities may nonetheless, but not necessarily, have some entities in common with one another. A multi-prediction module may be provided and configured to produce a set of values (e.g. a list of statistics) that indicate the probabilities of occurrence of the potential events.

In some embodiments, the probabilities may be mapped to probabilities that each one of a plurality of target entities will be the one called upon to handle the eventual event. Notably, the provided values (which may be probabilities or approximations thereof) are used to prepare for some or all of the potential events, each to an extent which is an increasing function of an associated value. For example, each one of the above-mentioned target network entities may proactively execute a certain number of operations for preparing for a potential event that might be handled thereby, where the number of operations is an increasing function of the value associated with that potential event.

In some embodiments, the probabilities (or values indicative of same) may be associated with processes to be performed. Each process may be performed by a same single target entity, or each process may be performed by a different associated target entity. Alternatively, each process may be performed by some associated collection of one or more target entities. For each of the potential events, the probability of occurrence (or an associated value) of that event is determined. Each probability (or value) is associated with a process to be proactively performed. One or more target entities are then caused to begin executing each one of the processes. The target entities are instructed to execute the processes to an extent which is an increasing function of its associated probability (or value). Thus, each probability (or value) is associated with both occurrence of an event and an extent to which a process, for accommodating the event (or requirements related to the event), is to be performed. In some cases, different target entities may execute a different instance of a same given process. In this case, the different instances may be regarded as different processes (because they are different instances thereof) even though they are similar.

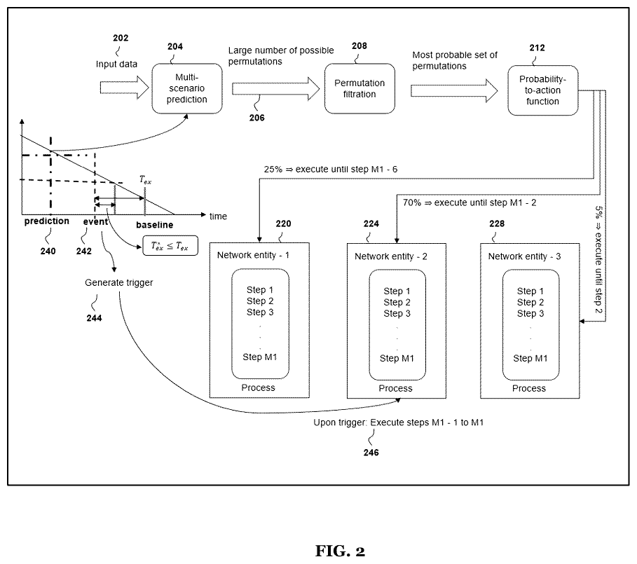

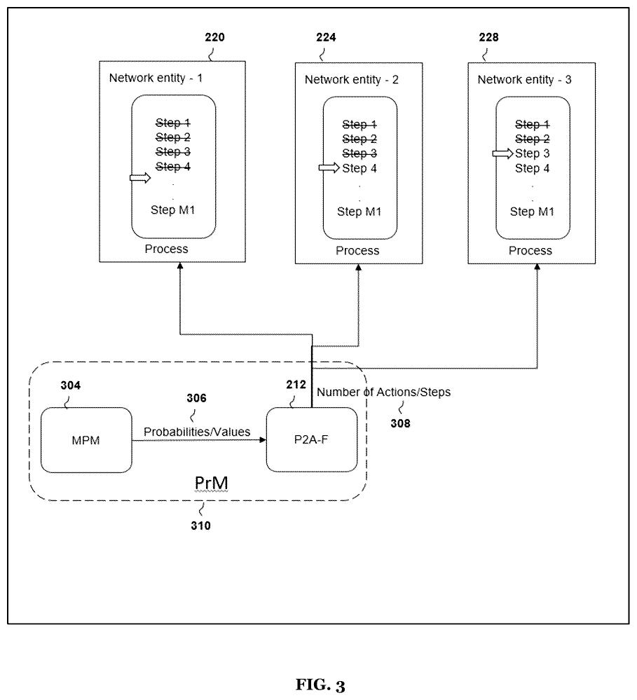

FIGS. 2 and 3 illustrate an embodiment of the present disclosure, particularly in the case that different network entities are called upon to proactively begin respective processes for accommodating different potential events. These may be first, second and third events which are alternatives of one another, so that only one of these events occurs. In some embodiments, the first, second and third events are all similar to one another, except that they require accommodation by different network entities (e.g. by different instances of a same process). As illustrated, input data 202 is provided to a multi-prediction module (MPM) 204. The input data 202 may include various data relevant to the predictions being made. For example, the input data may indicate location of a mobile user equipment, motion of the mobile user equipment, data or requests generated by the mobile user equipment, network conditions, sensor inputs, environmental data, etc. The MPM 204 generates a potentially large number of predictions 206 (also referred to as “permutations”) of potential future events based on the input data, relevant to the task at hand. If required, a filter 208 may receive the predictions and discard the less likely predictions. For this purpose, the MPM may also generate and provide, for each predicted event, an associated value indicative of probability of occurrence of that predicted event. The value may be an approximate probability, for example, or another metric which is an increasing function of the probability. The filter 208 may discard events which are associated with values which are below a threshold level, or events which are associated with values which are within a predetermined lowest kth percentile, for some predetermined value of k. The filter 208 may be omitted in some embodiments. The filter may be part of the P2A-F 212.

The output of the MPM, possibly after filtration, is provided as input to a probability to action mapper function (P2A-F) 212. The P2A-F is configured, for each potential future event provided thereto, to determine an extent to which an associated process, at an associated target network node, is to be performed proactively to prepare for that potential future event. The extent may be given as a number of operations (steps) of the associated process. The extent is an increasing function of the associated value indicative of probability for that event. The MPM 204 and P2A-F 212 may be components of a proactivity module (PrM).

For example, as illustrated, the probability that a first event will occur is determined to be 25%. To accommodate requirements related to the first event, a first target network entity 220 should proactively begin executing a first process. The P2A-F 212 thus causes the first target network entity 220 to begin executing this process, up to a first extent (e.g. up to six steps before the final step M1). The first target node will respond by beginning such execution then halt once step M1-6 (the sixth step before final step M1) is performed, awaiting further instructions. The further instructions may be instructions to perform further steps due to the assessed probability increasing, instructions to revert to a previous state due to the assessed probability decreasing, or instructions to complete the process due to the first event having actually occurred.

Similarly, the probability that a second event will occur is determined to be 70%. To accommodate requirements related to the second event, a second target network entity 224 should proactively begin executing a process, which may be another instance of the first process, or another process. The P2A-F 212 thus causes the second target network entity 224 to begin executing this process, up to a second extent (e.g. up to two steps before the final step M1). The first target node will respond by beginning such execution then halt once step M1-2 (the second step before final step M1) is performed, awaiting further instructions.

Similarly, the probability that a third event will occur is determined to be 5%. To accommodate requirements related to the third event, a third target network entity 228 should proactively begin executing a process, which may be another instance of the first process, or another process. The P2A-F 212 thus causes the third target network entity 228 to begin executing this process, up to a third extent (e.g. up to step 2). The first target node will respond by beginning such execution then halt once step 2 is performed, awaiting further instructions.

Once a trigger is received, indicative that one of the potential events (first, second or third event) has occurred, the trigger is provided to the associated target network node, causing that target network node to continue the process starting from the first unexecuted step. The trigger may be a message, control signal, or observed behavior from a network entity, for example, which is generated for example by a certain network entity in response to the event occurring. Alternatively, the results of the executed steps may be used in another way to support that target network node in accommodating the event which has occurred. As illustrated, at some time after the predictions 240 cause the network entities to begin proactively executing their processes, the second event 242 (for example) occurs. In response to the second event 242, the trigger 244 indicative that the second event has occurred is generated. This trigger 244 is sent to the second network entity 224, since the second network entity is to accommodate the second event 242 by performing all of a process. Upon receiving the trigger 244, the second network entity 224 executes 246 the remaining (as-yet unexecuted) portion of its pending process, i.e. steps M1-1 and M1. Thus, the process at the second network entity is completed to accommodate the event which has now occurred, starting from the extent to which it was previously executed. More generally, once the trigger 244 is received, results of any processes already performed can be used for accommodating the associated event.

The trigger 244 or another indicator that the second event 242 has occurred may also be provided to the first and third network entities 220, 228. Upon receipt of such indication, the first and third network entities may abandon or revert their preparations made by performing their processes, respectively. This may include releasing reserved resources, for example.

In some embodiments, the entirety of a process (e.g. at a given target network node) is only executed to completion after the event to be accommodated actually occurs. Prior to this, part of the process (such part being an increasing function of probability of the event occurring) may be executed proactively. For example, as shown in FIG. 3 (also FIG. 2), each target network node proactively performs a certain number (less than all) of the steps of a corresponding process as directed by the P2A-F, in anticipation of an associated potential event. Once an event actually occurs, the event causes a trigger to be sent to an appropriate one of the target network nodes. Receipt of this trigger causes the partially executed process at that network node to be continued starting from the first unexecuted step of the corresponding process. This may help make the approach compatible with current network function implementations. In FIG. 3, the MPM 304 provides values indicative of probabilities of events occurring, for example periodically, to the P2A-F 212. The P2A-F 212 determines an extent (e.g. number of actions or steps) to be performed by corresponding processes and provides corresponding instructions to the network entities 220, 224, 228 to perform the processes to such an extent (number of actions or steps 308) in response to the values provided by the MPM 304. For example, the P2A-F 212 instructs network entity 1 220 to execute the first four steps of a process due to the process being for accommodating a first event with relatively higher probability. The P2A-F 212 also instructs network entity 2 224 to execute the first three steps of the process due to the process being for accommodating a second event with relatively lower probability than event 1. The P2A-F 212 also instructs network entity 3 228 to execute the first two steps of the process due to the process being for accommodating a third event with relatively lower probability than event 1 and event 2. If event 1, 2 or 3 occurs, network entity 1, 2 or 3 is triggered to execute the remainder of its process respectively. The processes at each network entity may be different instances of a same process, or different processes. The other network entities are instructed to abandon their proactive execution. The MPM 304 and P2A-F 212 may be part of an overall proactivity module (PrM) 310.

It is also noted that, as further input data is received by the MPM, the probabilities of potential future events can be updated. This may cause the P2A-F to revise its outputs to different network entities. The revised outputs may include revised values indicative of probability of occurrence of events. This in turn may cause one or more network entities to execute their associated process to another modified extent, being an increasing function of the revised value. If the revised value is greater than the previously provided value, a further portion of the process (e.g. one or more additional steps, starting with the first unexecuted step) may be performed. If the revised value is less than the previously provided value, there are several possibilities. As one possibility, no further action is taken. As another possibility, the process may be reverted to a previous state (e.g. essentially undoing one or more actions). This second possibility is particularly relevant for example when one of the steps is to reserve resources (e.g. computing, memory or communication resources) that could be used elsewhere. Thus, such reserved resources may be released. The previous state may be a state in which the process is executed to an extent which is an increasing function of the revised value.

In view of the above, embodiments of the present disclosure provide a method, apparatus and system that utilizes a multi-scenario prediction module to produce predicted sets of potential future events and values indicative of probabilities of their occurrences. These predictions and associated values are used to prepare the network proactively in a manner that potentially shortens the execution time of typical network functions.

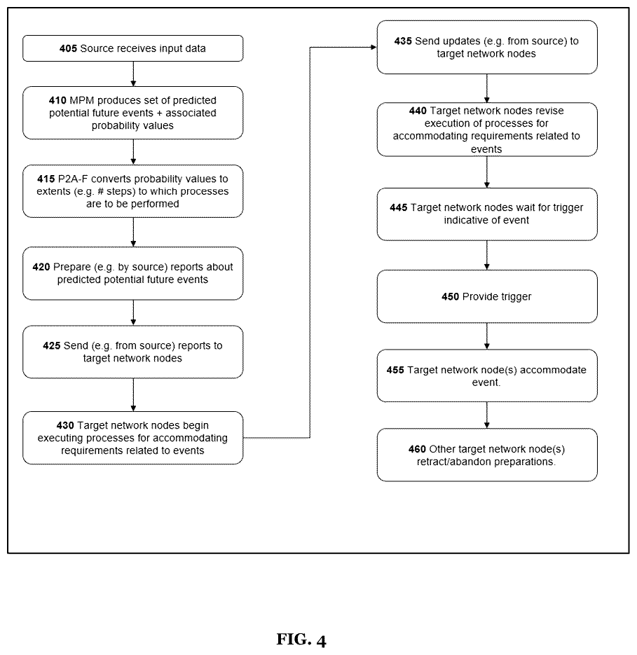

As illustrated in FIG. 4, associated operations may proceed as follows. In a first step 405, a network entity (source) receives input data that is used to run a multi-scenario prediction module (MPM). This may be implemented as part of the network entity or elsewhere in the network. The MPM may be related to a specific network function or operation.

The MPM produces 410 a set of predicted potential future events (which are alternatives to one another), along with a value indicative of probability of occurrence of each potential future event. The set of potential future events may also be referred to as permutations of an event, as they are alternatives to one another such that only one of the potential future events is expected to actually occur.

A prediction to action mapper function (P2A-F) converts 415 the values (e.g. probabilities of occurrences) into respective extents to which each corresponding process, for accommodating each potential future event, is to be performed. This may be a number of steps of a specific network function that needs to be completed proactively at an associated target network node, for example. The extent (e.g. number of steps to complete) may be determined by the P2A-F using a pre-defined mechanism, such as thresholding and one-to-one probability to step mapper. The P2A-F may define a particular number of steps of the process to complete at a given network entity.

Subsequently, one or more reports are prepared 420 that include individualized information about the predicted potential future events and their probability of occurrence (or associated values), the amount of a corresponding process (e.g. number of steps) to complete proactively, Event_ID, report_ID, and IDs of components that might be of interest. The potential future events, being alternatives of one another, may be associated with a single underlying event, which is also identified in the reports. For example, the events “mobile user equipment x requests to associate with a first base station,” “mobile user equipment x requests to associate with a second base station,” etc. may be associated with the event “mobile user equipment x selects to associate with a new base station. In some embodiments, the entity that prepares the report is the same source entity which received the input data at operation 405.

The reports are sent 425 (e.g. by the source entity) to their respective target network nodes (also referred to herein as entities or consumers) to proactively prepare for handling the different potential future events in an efficient manner. The target nodes then begin to execute 430 a corresponding process or processes for accommodating requirements related to the event. The process may include various steps to be executed at a given network node.

Updates to the reports may also subsequently be sent 435 (e.g. by the source entity) to the target network nodes. The updates may be sent periodically or upon request from a target network node, for example. The updates may include revised probabilities or associated values. The target network nodes, in receipt of the updates, may revise 440 their process execution, for example by executing more steps (if the probability is increased) or reverting to an earlier state (if the probability is reduced).

The target network nodes then wait 445 for one of the potential future events to actually happen. When one of the events happen, a trigger indicative of the event is provided 450 to one of the target network nodes, being the node which is to accommodate the event. This node, upon receipt of the trigger, uses results of the process proactively executed thereby to accommodate 455 the event. This may involve the node complete the remaining, heretofore unexecuted part of the process which it previously began executing proactively. Note that, not all target network nodes would receive a trigger in this scenario. Those nodes that do not receive a trigger do not complete the execution of the process which they previously begun. Instead, these nodes may proceed with retracting or abandoning 460 their proactive preparation upon receiving an indication that the event has happened and was taken care of by some other network nodes.

Each network node may retain a copy of the report(s) which it receives. These reports may be updated either periodically or a upon request. Furthermore, the set of IDs, such as the Event_ID and report_ID, may be used to identify the context of related communications. The reports can be incorporated into predefined protocols (e.g. control plane protocols). The reports can alternatively be communicated as a new type of data running between network entities (additional info+recommendations).

The proactivity process described above and elsewhere herein can be triggered by an event, performed periodically, or upon request. Otherwise, the network may operate in a conventional reactive manner, without proactively preparing for predicted potential events.

The MPM or associated network entity (also referred to as a source) and the target network nodes (consumer network entities) can be the same entities or separate entities. This may depend on the type of network function (1:1, 1:N) being operated proactively.

According to embodiments, as explained above, multiple processes are begun proactively, in anticipation of one of the multiple processes being required due to a subsequent trigger. The beginning of multiple processes increases the probability that the proactive preparations on the whole will be useful. When one of the processes is useful, the time required to complete this process is reduced, thus improving network response time. At the same time, the extent to which each process is performed may be purposefully limited. This allows the overhead cost, due to beginning multiple processes proactively, to be controlled and limited as necessary. By executing processes as an increasing function of probability of associated events occurring, efforts may be focused appropriately. Because overhead expended toward each one of the processes is limited, potentially more processes can be begun proactively. The multiple controllable parameters: the number of processes begun; the selection of which processes are begun; when the processes are begun; and the extent to which the processes are performed proactively, can be set in order to achieve a desired performance. The performance may be measured based on one or more of: the probability that one of the proactively begun processes is used; the expected response time to a related trigger; and the resource overhead usage to achieve such an outcome.

Embodiments of the present disclosure include a multi-prediction module (MPM) as mentioned above. An MPM may be configured to receive raw sensory data and/or information, and produce predictions about an event that is expected to happen in the future. The phrase “multi-prediction” refers to the fact that the module may be configured to observe a set of historical data and predict multiple possible outcomes, for example of events which are alternatives to one another (e.g. only one of the alternatives will occur). Those outcomes are referred to herein as prediction permutations, or simply permutations.

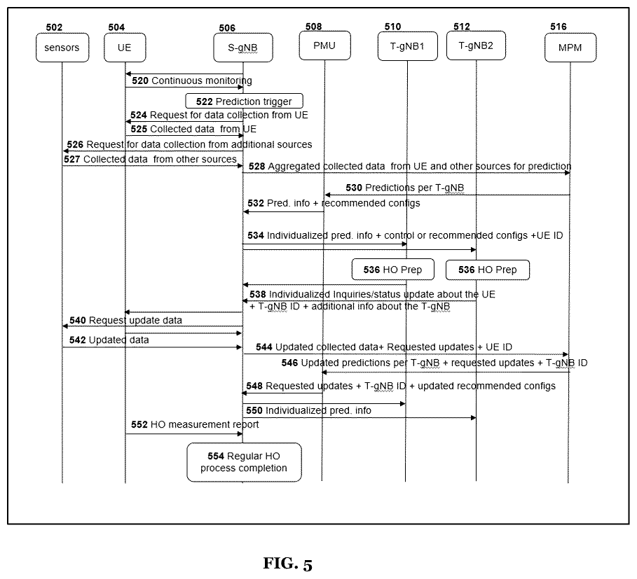

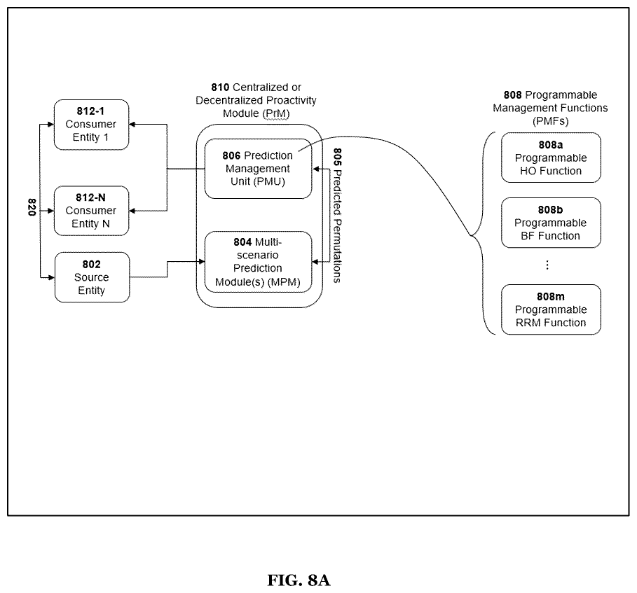

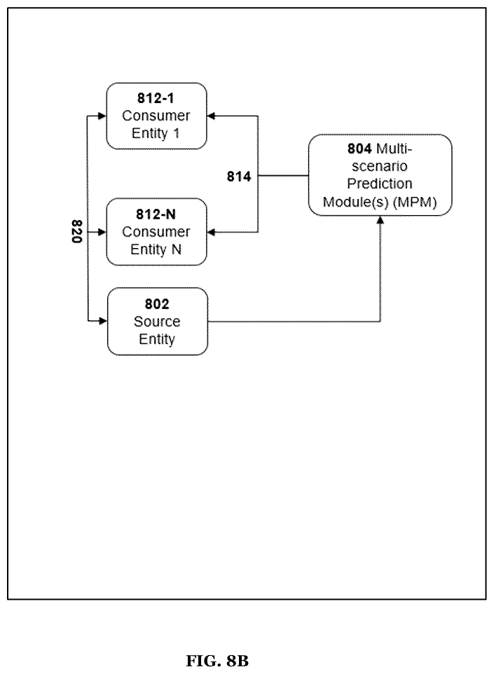

Embodiments of the present disclosure may also include a proactivity management unit (PMU) which will also be described elsewhere below, for example with respect to FIGS. 5 and 8A. After an MPM has produced prediction permutations, and has filtered them out, the PMU may receive the prediction permutations, remove those that are improbable or impossible (e.g. have a probability below a predetermined threshold), and keep only those that have a reasonable probability (e.g. above the threshold) of occurring. A probability of occurrence can be associated with each predicted permutation. The PMU may be configured to recalculate the probability of occurrence for each predicted permutation that survived the filtration stage. In short, the output of the PMU may be a shortened list of predicted permutations along with their respective probabilities of occurrence.

The output of the PMU can then be sent to and received by the probability-to-action mapper function (P2A-F). The P2A-F may use this output to specify certain courses of action for each network entity (NE) involved in handling the different predicted permutations of the predicted event.

Embodiments of the present disclosure can be implemented for a variety of purposes and in a variety of scenarios. An example scenario pertaining to proactively preparing for mobile user equipment handover events is described below.

The handover (HO) process in current mobile networks, by which a mobile UE associated with and communicating via a first base station (e.g. gNB) changes its association to a second base station (e.g. another gNB) is conventionally reactive by nature. In current 5G implementations, to initiate the handover, the mobile UE generates a measurement report (MR) and sends it to its serving gNB (S-gNB). The MR includes measurements of the signal strength towards the serving-gNB and one or more target gNBs (T-gNB). The S-gNB then determines the T-gNB with the highest measurement value and sends a HO request to it. The chosen T-gNB receives the request and performs its own admission control process. If the UE can be admitted at the T-gNB, the T-gNB sends an ACK to the S-gNB which in turn sends a HO command to the UE to initiate the handover towards the assigned T-gNB. If the chosen T-gNB cannot admit the UE, a NACK will be sent back to the S-gNB which would then be tasked with finding another T-gNB. As such, finding a proper T-gNB for the UE might take some time in the conventional process. In the case of fast moving UEs, this might lead to service droppage.

It is anticipated that the number of handovers required for a mobile user in future (e.g. 6G) networks may be considerably higher than in current networks. This may be due to network densification in which the number of gNBs are anticipated to increase dramatically for future networks, with corresponding decreasing coverage areas. Therefore, if each HO ends up being performed in a reactive manner, considerable delays may be present, negatively impacting performance.

To mitigate this, according to embodiments of the present disclosure, probabilities (or associated values) that a mobile UE will handover to each of multiple T-gNBs can be determined. These probabilities can then be used to direct each of these T-gNBs to proactively execute a corresponding operation to begin executing to a certain extent (e.g. a certain number of steps) to prepare for such a handover, prior to the actual handover being triggered (triggering being due to the UE sending a MR).

FIG. 5 illustrates a proactive handover preparation process according to an embodiment of the present disclosure. It should be noted that, according to such embodiments, T-gNBs can take an active role in the handover decision. This can involve opening a communication channel between T-gNBs and the S-gNB. This communication channel can be used to communicate updated predictions regarding future anticipated handovers, such as updated probabilities of a mobile UE initiating a handover.

According to FIG. 5, a S-gNB 506 monitors 520 a mobile UE 504, for example periodically or continuously. The S-gNB 506 may subsequently register a prediction trigger 522, which may be a trigger to predict potential future handover events involving the UE 504. In response to the prediction trigger 522, the S-gNB 506 requests 524 and collects 525 data from the UE 504. If available, the S-gNB 506 may also request 526 and collect 527 data from other sources, such as sensors 502. The other sources may possess information indicative of the UE 504, such as its location, behaviour, context, movement, etc., which may be useful in prediction of handover events. The S-gNB 506 sends 528 the (aggregated) collected data to a MPM 516. The MPM 516 generates predictions of potential future handover events for other base stations, in this case a number n of target gNBs T-gNB1 510, T-gNB2 512 up to T-gNBn (not shown). Each potential future handover event for a given base station is an event that the UE 504 will be handed over from the S-gNB 506 to the given target base station.

In some embodiments, the data collected and sent in operation 528 may include one or more of: a direction of travel over a certain past period, the UE's final destination for example in terms of GPS or map coordinates, the UE's current location, a type of data required, and other personalized information such as where the UE's user works, studies and/or lives, the current time of the day, typical behavior of the user during this time of the day, etc. Such information may be collected by the MPM 516 and can be used in generating the predictions of potential future handover events.

The MPM 516 sends 530 its predictions to the PMU 508 (for example after filtering). The predictions can be on a per-T-gNB basis. That is, the MPM 516 can provide, for each target gNB 510, 512, information indicative of a potential future handover to that target gNB, including the probability of occurrence. The information may include an expected UE location, time of arrival, expected probability of handover (or value indicative of such probability), expected type of service, expected amount of resources required, or the like, or a combination thereof. The information may include identifiers of the event being predicted. The T-gNBs and S-gNB may open communication channels with one another using such identifiers. The identifiers may include an event identifier (Event_ID), a report identifier (report_ID), or the like, or a combination thereof. The PMU 508 processes this information and provides 532, to the S-gNB 506, prediction information and recommended configurations. The S-gNB 506 may in response provide 534 individualized prediction information, control or recommended configuration information, along with an identifier of the UE 504 to some or all of the potential target gNBs T-gNB1 510, T-gNB2 512 up to T-gNBn. The prediction information may include the value indicative of probability that the UE will handover to the target gNB. The prediction information may alternatively include an extent to which preparations for a handover to the target gNB should be executed by the target gNB. The extent may be the number of steps in a process, and is an increasing function of the aforementioned value indicative of probability. The process may include admission control (AC), resource reservation, interacting with AMF, UPF, SMF, or other functions, or the like. The corresponding preparations for handover are then performed 536 up to the indicated extent.

Subsequently, the T-gNBs 510, 512 may send 538 individualized inquiries, status updates, or the like, to the S-gNB 506. The inquiries or updates may include information about the UE and the T-gNB (including an identifier, for example indicative of the combination of UE and T-gNB, or an identifier indicative of the predicted event, or the like). The information may include relevant information regarding the T-gNB. In response, the S-gNB 506 may request 540 updated data from the UE 504 and the sensors 502, and may receive 542 the requested updated data. The S-gNB 506 may then send 544 the updated collected data to the MPM 516. The MPM 516 may, in response, send 546 updated predications to the PMU 508. The predictions are similar to the predictions sent in step 530, but are updated based on the newly collected information. Thus, the probabilities of potential future handover events may differ from those previously provided, and can be referred to as revised values indicative of probability. The PMU 508 processes this information and provides 548, to the S-gNB 506, updated prediction information and updated recommended configurations. The S-gNB 506 may in response provide 550 updated individualized prediction information, control or recommended configuration information, along with an identifier of the UE 504 to some or all of the potential target gNBs T-gNB1 510, T-gNB2 512 up to T-gNBn.

The updated prediction information may include an updated (revised) value indicative of probability that the UE will initiate handover to the target gNB. The updated prediction information may alternatively include a modified extent to which preparations for a handover to the target gNB should be executed by the target gNB. The target gNBs, in receipt of this updated information, may revise their preparations. This may include performing their preparations to an additional extent if the updated probability is greater than the previous probability, or possibly reverting their preparations if the updated probability is less than the previous probability. In some cases, reverting is performed to the extent that it involves releasing reserved network resources. The steps 538 to 550, and the subsequent performing or revising of preparations at the gNBs may be repeated for example periodically.

Eventually, the UE 504 will trigger a handover to one of the T-gNBs by transmitting a HO measurement report 552 (or similar message) to the S-gNB 506. In response, the S-gNB 506 and the T-gNB to which the handover is being performed will cooperate with the UE to complete 554 the handover. These handover actions can leverage (use) the preparations for the handover, which are made as described above. The handover actions may include completing a process which is already started but not finished. This may include the above-mentioned preparations (e.g. according to 536) for handover as performed by the T-gNBs. The gNBs to which the UE is not being handed over can revert their own preparations, including releasing reserved network resources, if any.

Another example scenario pertaining to proactively preparing for mobile user equipment requests for user plane functions (UPF) is described below. This includes proactive UPF discovery and selection. The requests may be due to UE break points, for example.

For example, in 5G mobile networks, for a user equipment to connect to a data network (DN), the session management function (SMF) is responsible for creating a user plane connection from the radio access network (RAN) towards the DN. This user plane link has a number of user plane functions (UPFs) that are discovered and inserted there by the SMF to handle the traffic from and to the user equipment. However, users might require access to more than one service at the same time and those services might be located at different DNs. In the case that a user equipment requires a service provided by a DN that is not part of its already established user plane link, the user equipment sends a request to the session management function (SMF) which would then proceed with building a link towards the desired DN and insert the proper UPFs on the new link. This new link often forks from the already established user plane link. This process is known as forking and the point where the fork stems is referred to as the breaking point, or break point.

However, it should be noted that the SMF does not keep a record of the UPFs associated with different DNs. As such, in the current network, there is a forking process that is initiated once a request is received from the user equipment at the SMF. The process involves the following. First, the SMF receives the request from the user equipment, indicative of the desired DN to which a user plane connection is needed. Next, the SMF consults a database of UPFs close to (within the region of) the desired DN. Next, if proper UPFs are found in the database, then the SMF proceeds to create N4 links with those UPFs (if the links do not already exist). Otherwise, if the SMF cannot find appropriate UPFs within its database, it contacts the network repository function (NRF) to obtain access to more UPFs in the desired region. If the NRF has UPFs previously registered with it in the desired region, the NRF prepares a list of such UPFs and sends the list to the SMF. Otherwise, the NRF performs a UPF discovery process in which the NRF communicates with the UPF in that region if any. Next, the NRF updates its list of UPFs and sends the updated list to the SMF. Next, the SMF consults the updated list and selects the appropriate UPFs. Next, the SMF establishes N4 links towards the newly chosen UPF and creates the requested user plane link towards the DN desired by the user.

However, because the above process is reactive, the time taken to discover the UPFs, select the appropriate UPF(s), establish the N4 links, and build the user plane link results in a considerable amount of delay. Embodiments of the present disclosure may potentially reduce such delay significantly.

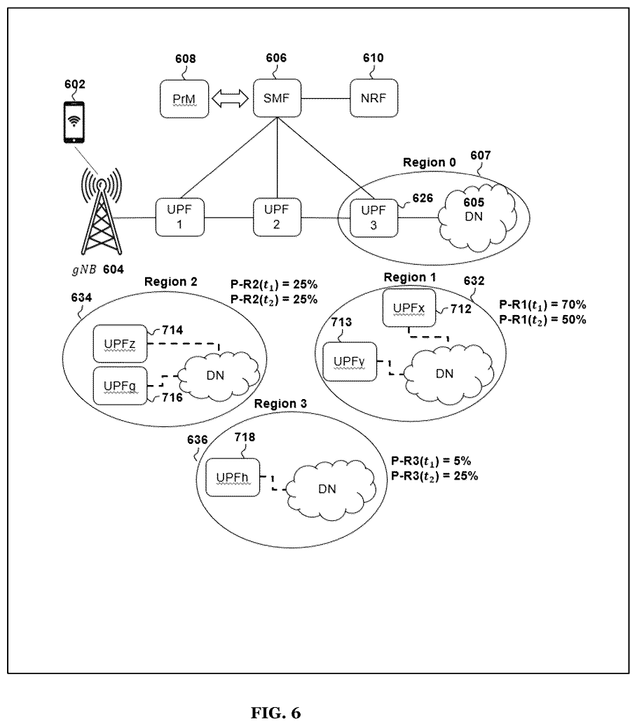

FIG. 6 illustrates an example system involving UPF discovery and selection, according to an embodiment of the present disclosure. A UE 602 is connected to a gNB 604 and currently has a user plane link towards the DN 605 in Region zero 607. The SMF 606 has access to the proactivity module (PrM) 608 which provides the SMF 606 with multiple predictions. The PrM 608 may include an MPM and a P2A-F, for example. At time t1, the predictions indicate that the UE might need to fork towards Regions 1, 2, and/or 3 (R1, R2, and R3 respectively), with probabilities P-R1, P-R2, and P-R3 respectively, where P-R1>P-R2>P-R3, for example purposes. Here it is assumed that the SMF does not keep a database of UPFs and thus will need to utilize the NRF 610 for UPF discovery. Region 0 607 involves already-discovered UPF 3 626. Three other regions are shown with initially undiscovered UPFs. These are Region 1 (R1) 630 with UPFx 712 and UPFy 713, Region 2 (R2) 634 with UPFz 714 and UPFg 716, and Region 3 636 with UPFh 718.

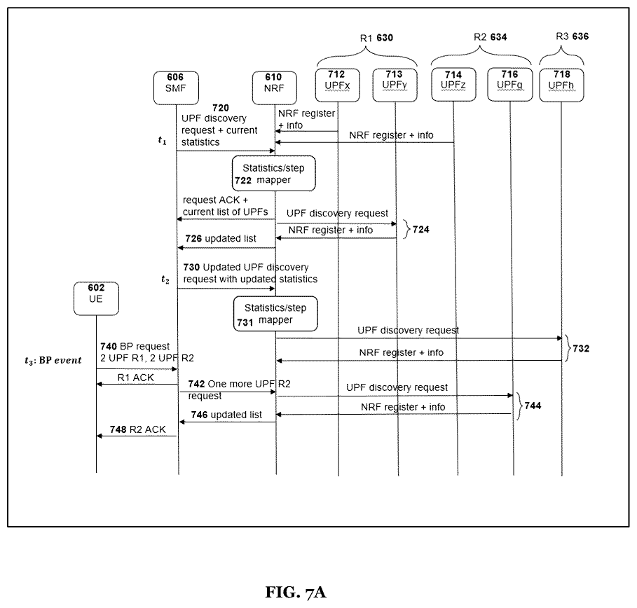

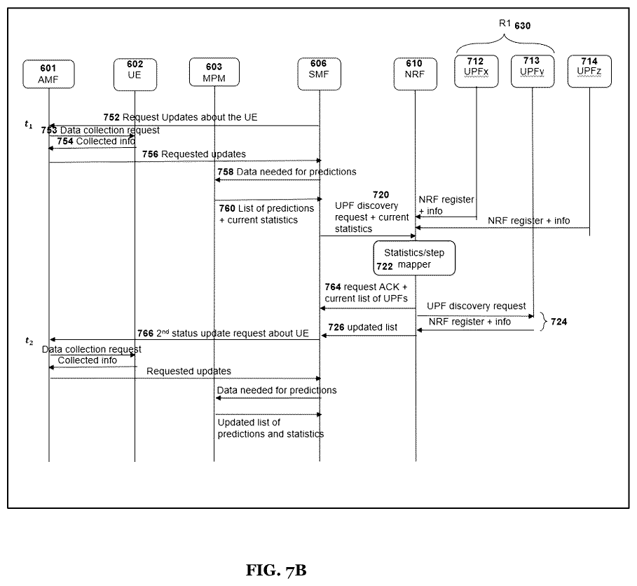

Initially, referring to FIG. 7A, the NRF 610 has only two UPFs registered, namely UPFx 712 from R1, and UPFz 714 from R2. However, after receiving a UPF discovery request 720 from the SMF with the probabilities for each region (e.g. probabilities that the UE will fork toward each region), the NRF 610 determines that, since P-R1 (at time t1) is high (above a certain threshold), a proactive UPF discovery operation in region R1 should be performed so as to have enough options ready for the SMF to choose from (in anticipation of the UE potentially forking toward R1). On the other hand, P-R2, although significant, does not cross the threshold to trigger a UPF discovery. Probability P-R3 is considerably low, thus no UPF discovery is performed for R3. The above determinations are performed by a statistics/step mapper 722 which may be equivalent to a P2A-F which may be part of the NRF 610. Accordingly, the NRF 610 discovers 724 UPFy from R1, adds UPFy to the list of UPFs, and sends 726 the updated list to the SMF 606. In turn, the SMF 606 proceeds with proactively building the N4 links towards the UPFs in R1. However, the SMF determines that the probabilities of R2 and R3 are low, so the SMF may determine there is no need to establish any N4 links.

At time t2, a new prediction arrives where now both P-R2 and P-R3 have increased. However, the increase in P-R2 is not significant, whereas that of P-R3 pushes it above the UPF discovery threshold. The updated probabilities are sent 730 from the SMF 606 to the NRF 610 which in turn determines (via statistics/step mapper 731) that it is now important to discover UPFs in R3, but not in R2 (because the NRF already has a UPF registered there). Accordingly, the NRF 610 discovers 732 UPFh in R3 and sends (not shown) the updated list to the SMF 606. The SMF then determines to establish an N4 link towards UPFz from R2 to account for the probability increase. The SMF does not establish an N4 link for UPFh as the probability did not cross a threshold of N4 link establishment at the SMF for this UPF.

Accordingly, times t1 and t2 correspond to times at which potential future requests for user plane functions are prepared for. There are several alternatives for user plane function requests. In this example the alternatives correspond to whether the UE will fork toward each of several alternative regions. For each alternative (i.e. for each potential future request), preparations are potentially made, by causing a corresponding process to begin executing. In this case, the process involves discovering one or more user plane functions in a corresponding one of the region toward which the UE potentially forks.

Referring back to FIG. 7A, at time t3, the breakpoint (BP) event occurs. The UE sends a breakpoint request 740 asking for 2 DNs, one in R1 and one in R2. This can be seen as a trigger. The requests also indicate that 2 UPFs per region R1 and R2 are needed to handle the service required. As the SMF has already registered both UPFx and UPFy from R1 registered and established the N4 links towards them, the SMF builds the user plane link towards DN in region R1 without further delay. Thus, results of proactive processes are used to accommodate the breakpoint request. On the other hand, for the DN in R2, one UPF is required in addition to the already registered UPFz. Thus, the SMF 606 sends a request 742 towards the NRF 610 which in turn discovers 744 UPFg in R2 and sends the updated list 746 to the SMF. The SMF then establishes the last N4 link towards UPFg and builds the user plane towards DN in R2 and sends an ACK 748 towards the UE. Thus, the request is accommodated by completing the corresponding process (discovering the required number of UPFs in the required regions) starting with the already proactively discovered UPFs and discovering further UPFs, as well as completing N4 linking to already discovered UPFs and newly discovered UPFs as required.

In view of the above, potential future requests (i.e. breakpoint requests) for user plane functions have been determined and responded to. For the response, part of a process for accommodating the requests is performed, including by discovering user plane functions. For example, the NRF proactively discovers UPFs. Furthermore, the SMF proactively builds N4 links to the discovered UPFs. The NRF and SMF may implement various modules or functions as described elsewhere for this purpose, for example an MPM, PrM, P2A-F, etc. For example, the NRF causes UPF discovery to be performed to an extent which is an increasing function of the current probability of occurrence of a request. As the probability changes, discovery performance can be adjusted, for example by discovering additional UPFs (e.g. UPFh). Thus, the discovery is performed to a modified extent based on a revised value indicative of probability of occurrence of a request. Although not shown, if a probability decreases, reserved network resources can be released, e.g. by tearing down an N4 link to a UPF.

FIG. 7B illustrates further details of the process of FIG. 7A, according to some embodiments. FIG. 7B should be read along (and interleaved) with FIG. 7A and shows certain operations which occur prior to operation 730 of FIG. 7A. Some of these operations of FIG. 7A are shown for reference. Some notable details are presented below.

As already described, the SMF 606 creates the connection from the UE 602 towards the DN of interest. This may include adding UPFs and running the user plane through them. When a forking event is requested, the SMF 606 contacts the NRF 610. The NRF 610 provides the SMF 606 with a list of UPFs in the required region. If the NRF 610 does not have UPFs registered in a region requested, the NRF 610 carries out a discovery process to discover and register new UPFs in the region of interest. Conventionally, this process is triggered when the SMF receives a request from the UE (a trigger).

In contrast, according to embodiments of the present disclosure, the discovery and selection of the UPFs may be done in a proactive manner according to a multi-prediction process. To do so, first, the SMF 606 communicates with the AMF 601 to request 752 information about the user (of UE 602) and/or the UE 602. The information is to help in making predictions of the next potential breakpoint (forking) event that could occur. In turn, the AMF 601 probes 753 the UE 602 for the data, gathers 754 the necessary information, and sends 756 the information back to the SMF 606.

The SMF 606 then sends 758 the collected data to the MPM 603. The MPM 603 then makes the predictions and compiles the list of prediction permutations (potential future events) along with their probability of occurrence. The list 760 is sent back to the SMF 606 which then determines if a UPF discovery request should be made. If the SMF 606 determines that a UPF discovery is needed, the UPF sends the discovery request 720 to the NRF 610. However, different from the traditional requests, here the SMF is making preparations in anticipation of a potential future breakpoint (BP). So, along with the request, the SMF 606 sends the statistics and the list of predictions to the NRF 610.

The NRF 610 includes or is operatively coupled to a P2A-F/PMU which assists the NRF in determining (e.g. via statistics/step mapper in 722) whether or not there is a need for registering more UPFs in a region. If enough UPFs are registered to accommodate the SMF's requisition, more UPFs may not be necessary. In this latter case, in which enough UPFs are registered, the list of currently registered UPFs is sent back 764 to the SMF. In the former case, where more UPFs are needed, the NRF 610 will first register 724 more UPFs (as a function of the probabilities indicated, as described elsewhere herein), and send 726 the updated list to the SMF 606. The SMF 610 then requests 766, from the AMF 601, one more additional status updates about the UE. With each status update requested, a procedure similar to the above (see e.g. operations 752, 753, 754, 756, 758, 760) is followed. Thus, the list of predictions and statistics can be updated. Additionally, other operations, such as the NRF 610 updating the list of the UPFs that is sent to the SMF 606, may also be repeated, following repeated UPF discovery operations similar to operations 720, 722, 764, 724, 726.

The SMF 606 also uses the statistics it received from the MPM 603 to perform its own P2A-F operations, to determine whether or not to build an N4 link towards a UPF proactively. The determination may be periodically or continuously updated as the status of the UE changes. Once the actual BP event happens (e.g. at indicated time t3 in FIG. 7A), the SMF 606 acknowledges the UPFs that it has previously prepared. The SMF 606 may further request additional UPFs from the NRF if required. As illustrated by way of example, UPFs in region R1 630 (UPFx 712 and UPFy 713) were ready before the actual BP event and thus are quickly acknowledged, whereas one UPF was missing in R2 630 and thus the SMF 606 discovers 744 an additional UPF (UPFg 716) after the BP event and before sending an ACK 748 to the UE 602.

FIG. 8A illustrates an embodiment of the present disclosure. A source network entity 802 generates the necessary data for the multi-scenario prediction modules (MPM) 804 to make predictions. The MPM 804 produces a list of potential future events based on the observed/collected data each along with their probability of occurrence (or value indicative of such probability). The potential future events may be alternatives of one another and may be referred to as ‘plausible’ predicted permutations (PPs) 805.

The list of PPs, their probabilities/values, and other necessary information are then sent to the proactivity management unit (PMU) 806 that includes programable management functions (PMFs) 808. The P2A-F may be implemented at the PMU for example by the PMFs. The PMFs may control the operation of the network entities, and may be part of the PMU. The PMFs are used to generate configurations/actions that would prepare the network ‘to handle all the PPs’ such that the proactivity performance is optimized. Examples of PMFs include a programmable handover function 808a, a programmable beamforming function 808b, and a programmable radio resource management function 808m. The MPM 804 and the PMU 806 together make up the proactivity module (PrM) 810 which can be implemented in a centralized or decentralized manner. The MPM 804 and the PMU 806 may be part of a proactivity module (PrM) 810, which may be centralized or decentralized. The source entity 802 and the consumer network entities 812-1 to 812-N are operatively coupled via a feedback link 820.

In some embodiments, the PrM 810 operates a controller that implements the actions in the consumer network entities 812-1 to 812-N. Thus, the output 814 of the PrM 810 toward the consumer network entities 812-1 to 812-N may be control data. In other embodiments, the PrM 810 (e.g. the PMFs 808 thereof) generate recommended configurations that are shared with the consumer network entities 812-1 to 812-N, possibly along with any other necessary information including probabilities or statistics, that may be used by the consumer node in processing the recommended configurations. The consumer network entities 812-1 to 812-N determine what to do with the information and recommended configurations. For example, the recommended configurations may include a recommendation to proactively begin executing a process to accommodate requirements related to a potential future event, as described elsewhere herein. Thus, the PrM may provide information to the consumer network entities for use in their operation, while the consumer network entities remain autonomous.

FIG. 8B illustrates another embodiment. As with FIG. 8A, a source network entity 802 generates the necessary data for the multi-scenario prediction modules (MPM) 804 to make predictions. The MPM 804 produces a list of potential future events based on the observed/collected data each along with their probability of occurrence (or value indicative of such probability). The potential future events may be alternatives of one another and may be referred to as ‘plausible’ predicted permutations (PPs).

The list of PPs, their probabilities/values, and other necessary information 814 are then sent to the consumer network entities 812-1 to 812-N. The P2A-F may be implemented at the consumer network entities 812-1 to 812-N. The consumer network entities determine how to use the information, for example by performing actions that would prepare the network ‘to handle all the PPs’ such that the proactivity performance is optimized. The process may be triggered, performed periodically, voluntarily, or upon request.

As discussed above, embodiments of the present disclosure involve a mapper function, such as the P2A-F. This mapper function may receive probabilities (or values indicative thereof) generated from a multi-scenario prediction module. The probabilities may indicate the likelihood of an associated network entity being the target node required to complete the execution of a standardized process such as completing a handover, UPF discovery and selection, and/or resource allocation and scheduling procedures. The probabilities may indicate the likelihood of an associated event taking place, requiring the completion of such a process. The probabilities (or values) may be converted into thresholds that determine the extent (e.g. number of steps) to which a process is to be proactively performed. As probabilities change, the processes may be completed to a greater degree or backed off (reverted) so that they are completed to a lesser degree. Such an approach may have one or more technical effects. The process execution time, measured from an event to the process accommodating the event being complete, can be reduced due to events being prepared for in a proactive manner and some operations being completed ahead of the event. This may be done while minimizing or limiting the required modifications to legacy network processes. This approach may provide for a reliable alternative to previous proactive solutions, while mitigating resource wastage for example due to mispredictions.

As discussed above, embodiments of the present disclosure comprise a source node configured to generate individualized targeted requests. An example targeted request is as follows. The request is labelled NE-1, and indicates P-NE1 as a probability of occurrence of the associated potential future event. The request may indicate a recommended number x of steps of a process to execute. The number of steps can be expressed as a fraction x1/N, where N is the total number of steps of the process. The request may indicate the expected event arrival time, e.g. in t1 seconds from now. The request may include an identifier Event_ID, which may be a hash created using object of interest ID (UE ID, SR ID, UPF discovery and selection request ID . . . etc). The request may include a report ID, which may be a hash created using combination of Event_ID+Target NE ID. Another request, labelled NE-2 may also be provided. If NE-1 and NE-2 are requests for two alternative events, then the probability of occurrence of the associated potential future event is P-NE2=1−P-NE1. The remainder of the request NE-2 may be similar to the request NE-1, but with different information, e.g. x2/N number of steps, expected arrival time in t2 seconds, etc.

Potential technical effects of the above generation of individualized targeted requests are as follows. The approach may provide a way to configure different network entities involved in handling a predicted event, considering the different parameters such as probability of occurrence of the event, and the time when the event would happen. New ID fields may be defined that can be used to refer to the prediction event and the report used to communicate the information from the source node towards the target nodes. Embodiments also provide for generation of the unique Event_IDs and Report_IDs used to identify the prediction event and the target network entity.

Embodiments provide for consumer network entities which can use the event ID and the report ID to enquire about the prediction event, receive updates from the source NE, or both. This may provide for a sample signal flow between the network entities to facilitate the implementation of embodiments as part of a standard.

Embodiments provide for a process trigger does not have to trigger a standardized process from beginning to end, but rather triggers the execution of an as-yet unexecuted remainder of the process. This gives context to how the execution time can be reduced in terms of what does the event trigger actually does and what it triggers.

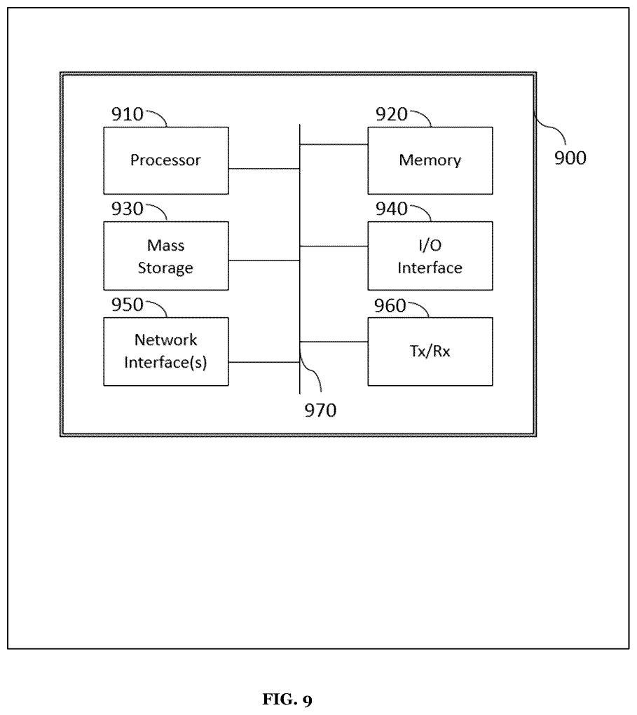

FIG. 9 is a schematic diagram of a computing device 900 that may perform any or all of operations of the methods and features explicitly or implicitly described herein, according to different embodiments of the present disclosure. For example, a computer equipped with network function may be configured as the computing device 900. One, two or more such computing devices may be coupled together in order to provide embodiments of the present disclosure. Multiple physically separate devices (e.g. in the same or separate datacenters) may be coupled together in order to provide one, two or more of such computing devices. When a device provides an infrastructure module, that device may consist primarily of an associated resource. For example, a computing module may consist primarily of computer processors, while a storage module may consist primarily of computer memory.

As shown, the device 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. According to certain embodiments, any or all of the depicted elements may be utilized, or only a subset of the elements. Further, device 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 1130 may include any type of non-transitory storage device, such as a solid state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the disclosure have been described herein for purposes of illustration, various modifications may be made without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the disclosure to provide a computer program product or program element, or a program storage or memory device such as a magnetic or optical wire, tape or disc, or the like, for storing signals readable by a machine, for controlling the operation of a computer according to the method of the disclosure and/or to structure some or all of its components in accordance with the system of the disclosure.

Acts associated with the method described herein can be implemented as coded instructions in a computer program product. In other words, the computer program product is a computer-readable medium upon which software code is recorded to begin executing the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to begin executing the methods provided in the embodiments of the present disclosure. For example, such an execution may correspond to a simulation of the logical operations as described herein. The software product may additionally or alternatively include a number of instructions that enable a computer device to begin executing operations for configuring or programming a digital logic apparatus in accordance with embodiments of the present disclosure.

Although the present disclosure and invention(s) associated therewith have been described with reference to specific features and embodiments, it is evident that various modifications and combinations can be made thereto without departing from such invention(s). The specification and drawings are, accordingly, to be regarded simply as an illustration of embodiments of the disclosure, for example as defined by the appended claims, and are contemplated to cover any and all modifications, variations, combinations or equivalents that fall within the scope of the present disclosure and its invention(s).

What is claimed is:

1. A method performed by an entity in a communication network, the method comprising:
following a determination, for the communication network, of two or more potential future events which are alternatives of one another:
for each event of the two or more potential future events:
determining a value indicative of probability of occurrence of the event;
causing a corresponding process to begin executing by one or more entities in the communication network prior to the occurrence of the event, to an extent which is an increasing function of the value, the corresponding process being for accommodating one or more requirements related to the event.

2. The method of claim 1, further comprising, prior to the occurrence of the event:
subsequently determining a revised value indicative of probability of the occurrence of the event;
causing the corresponding process for the event to execute to a modified extent which is an increasing function of the revised value.

3. The method of claim 2, wherein:
the executing to the extent includes reserving network resources, and
when the revised value is less than the value indicative of probability of occurrence of the event as previously determined, executing to the modified extent comprises releasing the reserved network resources.

4. The method of claim 1, further comprising:
receiving a trigger indicative of occurrence of a particular event of the two or more potential future events;
in response to the trigger, using results, of the executing of the corresponding process associated with the particular event, to accommodate one or more requirements of the particular event.

5. The method of claim 4, wherein accommodating the one or more requirements of the particular event comprises completing the corresponding process associated with the particular event, starting from the extent to which the corresponding process associated with the particular event was previously executed.

6. The method of claim 4, further comprising, following receipt of the trigger, abandoning or reverting each of the corresponding processes which are associated with each of the two or more potential future events other than the particular event.

7. The method of claim 1, wherein each different process of the corresponding processes is executed using a different respective set of one or more entities.

8. The method of claim 1, wherein the entity the communication network, at least one of the one or more entities, or a combination thereof comprises: a user equipment, one or more base stations serving the user equipment, a base station which is a neighbor base station of the user equipment, or an entity in a core network.

9. The method of claim 1, wherein each corresponding process corresponds to one of:
a process for handing over a user equipment between base stations;
a process for user plane function discovery for accommodating the user equipment; or
a process for beam selection at a base station for communicating with the user equipment.

10. A method performed by an entity in a communication network, the method comprising:
following a determination, for the communication network, of two or more potential base stations with which a mobile user equipment may potentially communicate at a future time:
for each base station of the two or more potential base stations:
determining a value indicative of probability of initiating by the mobile user equipment a handover to the respective base station;
causing a corresponding process to begin executing by one or more entities in the communication network prior to the initiating the handover to the respective base station, to an extent which is an increasing function of the value, wherein the corresponding process comprises preparing for the handover.

11. The method of claim 10, further comprising, prior to the initiating the handover, for each base station of the two or more potential base stations:
subsequently determining a revised value indicative of probability of the initiating the handover;
causing the corresponding process to execute to a modified extent which is an increasing function of the revised value.

12. The method of claim 11, wherein:
for each base station of the two or more potential base stations:
the executing to the extent includes reserving network resources, and
when the respective revised value is less than the respective value indicative of probability of the initiating the handover as previously determined, the executing to the modified extent comprises releasing the respective reserved network resources.

13. The method of claim 10, further comprising:
subsequently receiving a trigger indicative that the mobile user equipment has initiated the handover to a particular one of the base stations;
in response to the trigger, performing the handover to said particular one of the base stations using results of the executing of the corresponding process by the one or more network entities, wherein the one or more network entities comprise said particular one of the base stations.

14. The method of claim 13, wherein performing the handover comprises completing the corresponding process by the one or more network entities, starting from the extent to which the corresponding process was previously executed.

15. The method of claim 10, wherein the entity in the communication network, at least one of the one or more entities, or a combination thereof comprises: a user equipment, one or more base stations serving the user equipment, a base station which is a neighbor base station of the user equipment, or an entity in a core network.

16. The method of claim 13, further comprising, following receipt of the trigger, abandoning or reverting each of the corresponding processes which are associated with each of the two or more potential base stations other than the particular one of the base stations.

17. A method performed by an entity in a communication network, the method comprising:
following a determination, for a communication network, of two or more potential future requests for user plane functions, the two or more potential future requests being alternatives to one another:
for each request of the two or more potential future requests:
determining a respective value indicative of probability of occurrence of the respective request;
causing a corresponding process to begin executing by one or more entities in the communication network prior to the occurrence of the respective request, to an extent which is an increasing function of the value, the process corresponding to the respective request comprising a process of discovering corresponding user plane functions, linking to discovered user plane functions, or both.

18. The method of claim 17, further comprising, prior to the occurrence of the respective request:
subsequently determining a respective revised value indicative of probability of the occurrence of the respective request;
causing the corresponding process for the respective request to execute to a modified extent which is an increasing function of the respective revised value.

19. The method of claim 18, wherein:
executing to the extent includes reserving network resources, and
when the respective revised value is less than the respective value indicative of probability of occurrence of the request as previously determined, executing to the modified extent comprises releasing the reserved network resources.

20. The method of claim 17, further comprising:
subsequently receiving a trigger indicative of occurrence of a particular request of the two or more potential future requests;
in response to the trigger, using results of the corresponding process associated with the particular request, to accommodate the particular request.
